(19) United States
(12) Patent Application Publication
(10) Pub. No.: US 2025/0260208 A1
(43) Pub. Date: Aug. 14, 2025

(54) MODE-LOCKING METHOD AND SYSTEM

(71) Applicant: INSTITUT NATIONAL DE LA RECHERCHE SCIENTIFIQUE, Québec (CA)

(72) Inventors: Imtiaz ALAMGIR, Montréal (CA); Luigi DI LAURO, Montréal (CA); Aadhi ABDHUL RAHIM, Kingston (CA); Bennet FISCHER, Jena (DE); Nicolas PERRON, Longueuil (CA); Pavel DMITRIEV, Montréal (CA); Celine MAZOUKH, Montréal (CA); Piotr ROZTOCKI, Longueuil (CA); Yoann JESTIN, Montréal (CA); Roberto MORANDOTTI, Montréal (CA)

(21) Appl. No.: 19/047,843

(22) Filed: Feb. 7, 2025

Related U.S. Application Data
(60) Provisional application No. 63/551,115, filed on Feb. 8, 2024.

(51) Int. Cl. H01S 3/067

(52) U.S. Cl. CPC H01S 3/06712; H01S 3/0675; H01S 3/06791

(57) ABSTRACT

A mode-locking laser method and system, using an external cavity for propagation of an optical field and its propagating modes; a microring resonator selected as a nested cavity to filter and resonate multiple external cavity modes and applying nonlinearity on the optical field; a gain unit, selected to amplify the optical field in the external cavity; a polarization controller, selected to control a polarization state within the system; a phase modulator selected for actively modulating phases of the nested cavity modes to achieve mode-locking; a photodetector, selected for converting optical signals into electrical signals for detection; a synthesizer, selected to generate a frequency-modulated signal for establishing a fixed phase relationship; and a tunable filter, with a bandwidth selected to select a variable number of microring resonator resonances, generating of mode-locked pulse burst trains with coexisting nanosecond and picosecond timescales and broadband comb generation with tunable central wavelength.

### CROSS REFERENCE TO RELATED APPLICATIONS

This application claims benefit of U.S. provisional application Ser. No. 63/551,115, filed on Feb. 8, 2024. All documents above are incorporated herein in their entirety by reference.

### FIELD OF THE INVENTION

The present invention relates to mode-locking. More specifically, the present disclosure concerns a mode-locked laser system and method.

### BACKGROUND OF THE INVENTION

Mode-locking is a method that synchronizes the phases of multiple longitudinal modes in a laser cavity to generate stable optical pulse trains with properties determined by a number of external cavity parameters such as, for example, pump power, polarization, as well as internal cavity parameters including cavity configuration, dispersion and round-trip time. Mode-locked fiber lasers are versatile platforms that provides robust design and broad transmission window, in which mode-locking is achieved by modulating the cavity loss using either active or passive modulation methods, thus generating pulses with a different duration (quasi-continuous to ultrafast) and repetition rates (REPs) (MHz to GHz).

Passive mode-locking allows for the formation of optical pulses with durations ranging from nanoseconds to femtoseconds. This has been demonstrated with the investigation of different saturable absorbers based on real materials, such as graphene and carbon nanotubes, as well as artificial platforms, such as, for example, nonlinear amplifying loop mirrors and microring resonators (MRRs), leading to the development of compact and efficient mode-locking systems. They have led to significant technological developments in different fields, such as in quantum optics in relation to entangled photon sources, as well as in neuromorphic computing. Mirroring resonators (MRRs) offer a compact, integrable, and efficient alternative for the generation of mode-locked pulses in both continuous wave and pulsed pumping regimes in passive mode-locking configurations. For instance, in coupled cavity systems, including the filter-driven four-wave mixing system for example, passively mode-locked soliton microcombs can be produced by nesting a linear/nonlinear fiber loop cavity, such as a waveguide, of a size different from the size of the external fiber cavity, or a microring resonator (MRR), within an external fiber loop cavity. In this case, the presence of several resonating field components in the external fiber cavity contributes to mode beating and drifting of the central frequency due to the thermo-optical effect and environmental noise. Furthermore, such a method requires spectral filtering to select the desired cavity mode resonance and suppress the remaining modes, drastically increasing the lasing threshold, reducing the bandwidth, and introducing system complexity. These issues have been later mitigated by reducing the total length of the external fiber cavity, which has resulted in a more efficient and stable generation for laser cavity microcombs, thus leading to the generation of ultrashort, picoseconds pulses.

Conversely, nanosecond pulses generation by passive mode-locking methods remains challenging due to the adverse operation timescale of the saturable absorbers and low nonlinear effects reached by nanosecond pulses. Laser cavities with exceptionally long propagation length generate nanosecond pulses with pronounced chirp, relatively lower peak power compared to ultrashort pulses and KHz repetition rate (REP) that restricts their suitability in several applications in nonlinear optics. An alternative method involves pulse generation exploiting gain switching dynamics; however, the feasibility of such a method is generally limited due to the need for high-energy pump sources. Other methods, such as figure-8 configurations with nested microring resonators (MRRs), provide large field enhancement and ultranarrow filtering that can generate transform limited ultranarrow bandwidth nanosecond pulses. Similar to filter driven four-wave mixing method, this method relies on a narrowband filter to enhance specific modes, which may limit the flexibility to generate combs with varying mode spacings or bandwidths.

Active mode-locking methods are employed to generate pulses with durations between a few picoseconds to hundreds of nanosecond. This is generally achieved by modulating the phase, frequency, or amplitude of the intra-cavity fields using electro-/acousto-optic modulators. Active mode-locking systems benefit from a lower pump power threshold and are not affected by undesired nonlinear optical effects such as, for example, thermo-optical effects, often seen in passive systems. Similarly to the case of passive methods, fiber cavities with nested configurations also represent suitable configurations for active mode-locking lasers. In one such demonstration, multiple external cavity modes are selected to oscillate within the linewidth of a single microring resonator (MRR) resonance. These external cavity modes can be phase-locked by driving the cavity with an amplitude modulated signal at a frequency. The later is identical to or multiple of the external cavity mode spacing, thus generating stable nanosecond mode-locked pulse trains.

Using a polarizer and a modulator for passive mode-locking and achieving active modulation by driving the modulator with a single radiofrequency (RF), i.e. carrier frequency corresponding to the microring resonator free spectral range (MRR FSR) changing the polarization of the resonating modes in the microring resonator (MRR), thus changing the lasing efficiency.

Despite advancements in nested cavity configurations, controlling the temporal and spectral characteristics of mode-locked microcombs remains a challenge. First, the potential for a single laser cavity to simultaneously produce extreme events across both nanosecond and picosecond scales, combined with an efficient switching system between them, remains unexplored. For instance, high-energy nanosecond pulses promise numerous applications, such as micromachining and the realization of a pump source for mid-infrared pulse generation, while the picosecond-long GHz microcombs may find application in ultrafast precision spectroscopy and optical computing. As discussed hereinabove, modern laser systems are built on distinct cavity configurations and mode-locking systems, and are tailored to meet specific pulse generation regimes, either in picoseconds or nanoseconds. A number of mode-locked systems and methods, such as for example harmonic mode-locking methods, offer a limited range of tunability, typically limited to variations of a few picoseconds in pulse duration. Relatively enhanced tunability is obtained through the modification of key cavity components, such as integrating the Fabry-Perot etalon as an intracavity filtering system, also resulting in increased operational complexity and maintenance needs. Thus, methods of the art still fail in a nested cavity configuration as a more flexible method to mode-locked spectral comb generation. Second, achieving passive and flexible control over microcomb spectral properties, such as center wavelength is still a challenge. Continuous wave and pulsed excitation techniques are common methods of microcomb generation. In both cases tuning the microcomb center wavelength is complicated. For example, the tuning of the central wavelength of a microcomb is dependent on combined effects of its group velocity dispersion (GVD), which is determined by both geometrical and material factors. Since material group velocity dispersion (GVD) tends to be normal, obtaining target microcomb spectra necessitates a resonator of specific size and shape to achieve anomalous group velocity dispersion (GVD), imposing limitations on generating combs with arbitrary central wavelength. State of the art wavelength tuning methods use electro-optic or thermo-optic effects, and thus remain limited to specific systems for either a pronounced thermo-optic or a strong Pockels coefficient, respectively. The efficiency of these tuning methods remains relatively low in comparison to the free spectral range (FSR) of the microresonator, thereby making adjusting the microcomb across a span significant relative to the free spectral range (FSR) a challenge.

There is still a need in the art for a mode-locking method and system.

### SUMMARY OF THE INVENTION

More specifically, in accordance with the present invention, there is provided a mode-locking laser system comprising an external cavity selected for propagation of an optical field and propagating modes thereof; a microring resonator selected as a nested cavity to filter and resonate multiple external cavity modes, and applying nonlinearity on the optical field; a gain unit selected to amplify the optical field in the external cavity; a polarization controller selected to control a polarization state within the system; a phase modulator selected for actively modulating phases of nested cavity modes to achieve mode-locking; a photodetector selected for converting optical signals into electrical signals for detection; a synthesizer selected to generate a frequency-modulated signal for establishing a fixed phase relationship; and a tunable filter, with a bandwidth selected to select a variable number of microring resonator resonances.

There is further provided a mode-locking laser method, comprising selecting a microring resonator as a nested cavity to filter and resonate multiple external cavity modes and apply nonlinearity on an optical field; selecting an external cavity for propagation of the optical field and its propagating modes; selecting a gain unit to amplify the optical field in the external cavity; selecting a polarization controller to control a polarization state within the system; selecting a phase modulator for actively modulating phases of the cavity modes to achieve mode-locking; selecting a photodetector for converting optical signals into electrical signals for detection; selecting a synthesizer to generate a frequency-modulated signal for establishing a fixed phase relationship; and selecting a tunable filter to select a variable number of microring resonator resonances.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a flowchart of a method according to an embodiment of an aspect of the present disclosure;

FIGS. 2 show mode-locked regime with multiple timescales according to an embodiment of an aspect of the present disclosure: the temporal and spectral profiles of coexisting nanosecond and picoseconds timescales, with 8.5 mW average output power, for a 100 GHz filter bandwidth, corresponding to two microring resonators (MRRs) resonances, the center wavelength being at 1549.3 nm; FIG. 2A shows nanosecond pulse train; FIG. 2B shows a single nanosecond pulse featuring a Gaussian temporal profile of 5.1 ns width, recorded using a photodiode and a real-time oscilloscope; FIG. 2C shows radiofrequency (RF) spectrum of the trace, indicating a fundamental repetition rate of 4.4 MHz, the inset displaying the fundamental radiofrequency (RF) tone measured with a resolution of 2.9 kHz; FIG. 2D shows a time trace of a train of pulses with a repetition rate of 48.7 GHz, recorded using the optical sampling oscilloscope; FIG. 2E shows corresponding autocorrelation trace of the pulse, the width, measured using an autocorrelator (dots), being 3.1 ps, perfectly overlapping a sech function profile (solid line); and FIG. 2F shows the optical spectrum of the multiple timescale mode-locked regime with a frequency comb;

FIG. 3A shows mode-locking threshold reduction according to an embodiment of an aspect of the present disclosure;

FIG. 3B shows comb center wavelength tuning according to an embodiment of an aspect of the present disclosure;

FIGS. 4 show stability characterization of the mode-locked operation obtained in the same experimental conditions as in FIGS. 2: FIG. 4A shows power stability measurement over 12 hours, presenting a low root-mean-square (RMS) fluctuation of 0.19% and proving the robustness of operation; FIG. 4B shows relative intensity noise (RIN) characterization of the laser with nano and picosecond components, with (lower curve) and without (top curve) mode-locking;

FIG. 5 shows a schematic view of a mode-locking laser according to an embodiment of an aspect of the present disclosure; an upper inset schematically illustrating the RF spectrum of the frequency-modulated signal that establishes a fixed phase relationship among all adjacent oscillation modes within multiple microring resonator (MRR) modes;

FIG. 6 shows multiple timescales mode-locking according to an embodiment of an aspect of the present disclosure;

FIGS. 7 show effect of GHz modulation: FIG. 7A shows incoherent beating among the pulses without modulation; FIG. 7B shows broadening of the radiofrequency (RF) spectrum in the absence of modulation, resulting in a linewidth of approximately 0.4 MHz (red spectrum); modulation) was obtained in the same regime as in FIGS. 2, resulting in a narrower linewidth of 2.9 KHz; and

FIGS. 8 show laser operation without modulation: FIG. 8A shows comb spectra achieved by adjusting the bandwidth of the intracavity filter with different resonant modes m=2, 6, and 11, corresponding to spectral bandwidths of 100 GHz, 300 GHz, and 550 GHz, respectively, the comb spectra broadening from 1.2 nm to 4.1 nm and 9.2 nm around 1550 nm for m=2, 6, and 11, respectively, when considering a 10 dB intensity variation concerning the center comb line, having the highest intensity; FIG. 8B shows time-domain characterization in the nanosecond timescale using autocorrelation characterization with a filter bandwidth of 300 GHz; FIG. 8C shows time-domain characterization in the picosecond timescale, using autocorrelation characterization with a filter bandwidth of 300 GHz; FIG. 8D shows frequency comb generation obtained by varying the central wavelength of the tunable filter (the bandwidth is fixed at 550 GHz), the observed spectral broadening being 6.0 nm, 9.2 nm, and 7.8 nm (from top to bottom of FIG. 8D, respectively), when considering a 10 dB intensity variation with respect to the center comb line, having the highest intensity.

### DESCRIPTION OF ILLUSTRATIVE EMBODIMENTS

The present invention is illustrated in further detail by the following non-limiting examples.

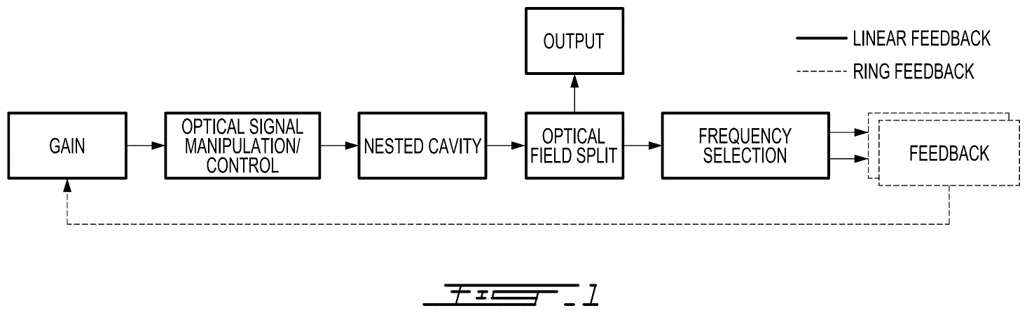

A method and a system according to an embodiment of an aspect of the present disclosure as shown in FIG. 1 uses both the linear and nonlinear interactions of an external cavity field with a nested cavity, with an external cavity being driven by an optical field manipulation device. Both cavities are selected with large dimension mismatch that translates into a three order magnitude difference in their free spectral range (FSR) as determined by the size of a fiber and microring resonator (MRR) used for the nested cavity for example; different configurations, fibers, components and materials may be selected for a double-loop configuration or a nested configuration. The nested cavity acts as a filter, selectively allowing multiple external cavity modes to fit within a single nested cavity resonance. Different implementations of the nested cavity may be contemplated, such as for example microring resonators (MRRs) as mentioned hereinabove, Fabry-Perot etalons, Bragg grating filters and photonic crystal resonators. Mode-locking is achieved as both the nested and the external fiber cavity modes are simultaneously phase locked by using an optical signal manipulation and control unit to achieve active optical signal manipulation and control; a number of optical phase modulators electro-optic, semiconductor, acousto-optic, photonic crystal and liquid crystal phase modulators may be selected.

An amplified spontaneous emission based fiber amplifier may be used as the gain unit to amplify the circulating optical field; other broadband optical sources may be selected, such as semiconductor optical amplifier and Raman amplifier for example. A tunable thin-film filter is used to select the central wavelength of the laser and target resonances of the nested cavity, which determines the access and control of different pulse generation regimes; a diffraction grating-based filter may also be used. For optical field splitting and coupling to output monitoring, an optical beam splitter such as for example fused optical fiber couplers, neural density filter based optical couplers, and multimode interference couplers, may be used. The mode-locking operation is obtained in two feedback configurations: FIG. 1 shows a ring feedback in a ring cavity configuration in stippled lines and a linear feedback in a linear cavity configuration in solid line, according to embodiments of an aspect of the present disclosure. The ring cavity configuration uses optical fibers to circulate the signal, while the linear cavity configuration uses fiber-coupled gold mirrors or a diffraction grating in the Littrow configuration for example, merging both the frequency selection and feedback steps. The entire external cavity may be implemented in fiber or using free-space counterparts.

In experiments, the mode-locking method and system with ring cavity feedback were demonstrated using a high-Q and highly nonlinear microring resonator (MRR) with a free spectral range (FSR) of 48.7 GHz and a linewidth L lower than 120 MHz and a fiber cavity of 34.4 m (FSR 6 MHz) as nested and external fiber cavity. Therefore, a total of about 20 external cavity modes resonate within the single spectral width of the microring resonator (MRR). The external cavity modes are excited in two stages: first, the amplifier gain is increased to amplify the external cavity modes that resonate inside the laser cavity, subsequently inducing four-wave mixing (FWM) in the microring resonator (MRR), resulting in a broadening of the overall spectral bandwidth of the comb, without ensuring that the random beating between of the large number of external cavity modes results in an unstable operation and the mode-locking condition. Similarly, the multiple microring resonator (MRR) modes are also phase mismatched with respect to each other. To ensure that a phase locking condition is satisfied between them, both the external cavity and the microring resonator (MRR) modes are actively modulated. In these experiments, an electro-optic phase modulator is operated with frequency a modulated signal at the sub-harmonic of the microring resonator free spectral range (MRR FSR) of 24.34 GHz and with a modulating signal frequency identical to external cavity free spectral range (FSR), using a radiofrequency (RF) synthesizer, for example of nested configuration. By selecting multiple microring resonator (MRR) modes using tunable gaussian filter, mode locking and simultaneous generation of optical pulses with two distinct timescales are established.

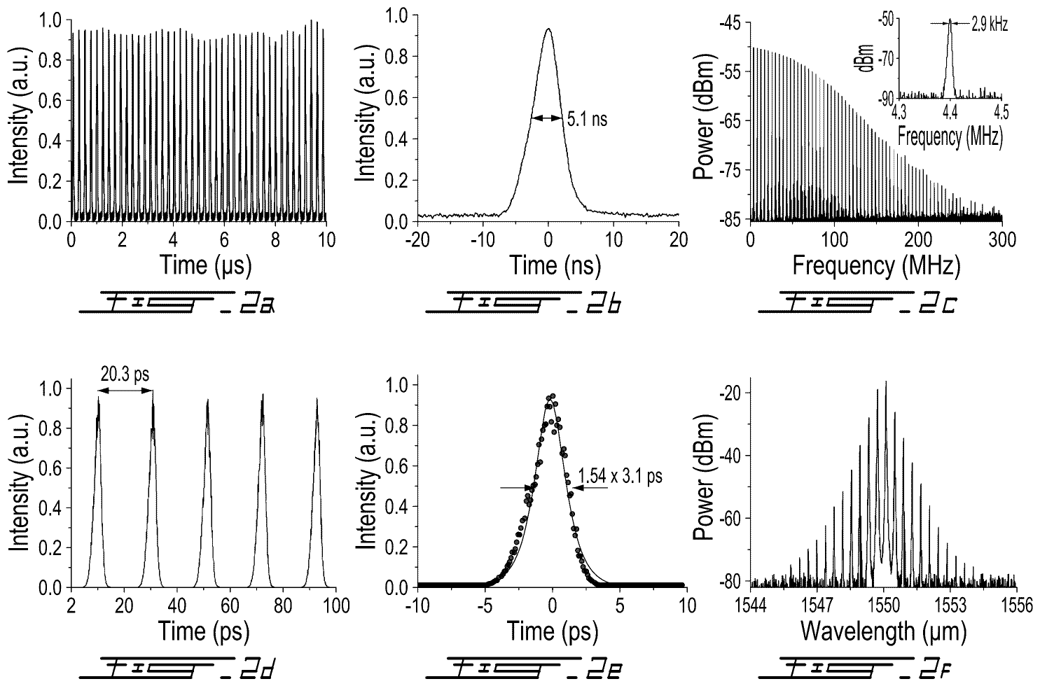

FIGS. 2 show mode-locked regime with multiple timescales according to an embodiment of an aspect of the present disclosure, with the temporal and spectral profiles of coexisting nanosecond and picoseconds timescales, with 8.5 mW average output power, for a 100 GHz filter bandwidth, corresponding to two microring resonators (MRRs) resonances, the center wavelength being at 1549.3 nm. As the mode-locking is achieved, the external cavity modes establish a fixed phase-relationship between all the adjacent oscillation modes. As a result, the pulse trains have the repetition rate of external cavity free spectral range (FSR), with the temporal profile and the gaussian pulse profile with 5.1 ns FWHM, with a transform limited time-bandwidth product of 0.5, as shown in FIG. 2A and FIG. 2B, respectively. FIG. 2C shows highly coherent RF spectral components spaced of 6 MHz, indicating phase-locking between all the distinct external cavity modes oscillating in each microring resonator (MRR) resonance.

Similarly, ultrashort pulse regime is simultaneously observed using a high-bandwidth optical sampling scope and a commercial autocorrelator. FIGS. 2D-2F show the measurements of the pulse trains, pulse width, and the corresponding optical spectra, respectively. The measured dynamic has a repetition rate of 48.7 GHz, matching the free spectral range (FSR) of the microring resonator (MRR) while having a sech pulse profile (3.1 ps width), with a transform-limited time-bandwidth product of 0.46. The spectral profile of FIG. 2F shows that the signal bandwidth exceeds 1 THz. The results shown in FIGS. 2 clearly prove the coexistence of both timescales in the emitted pulses, demonstrating generation of pulses in the regime of a few ns and a few ps; the method and system may be adapted for a range of different timescales by selecting nested and external cavity parameters.

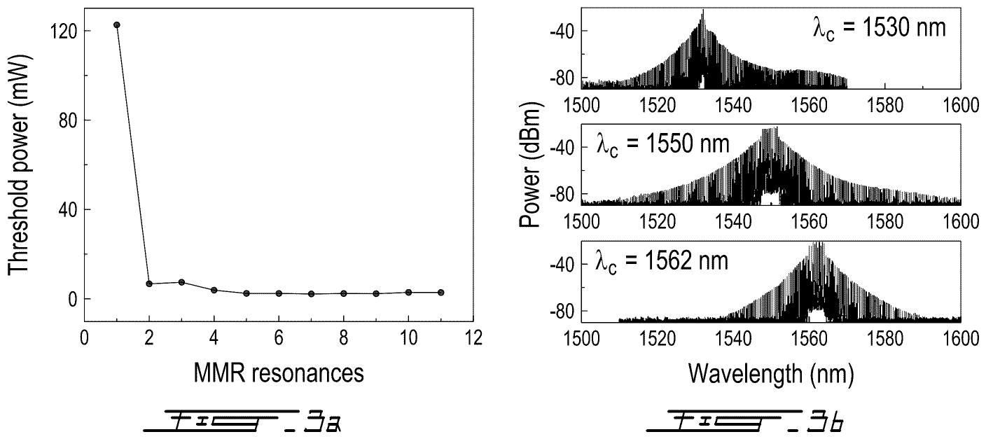

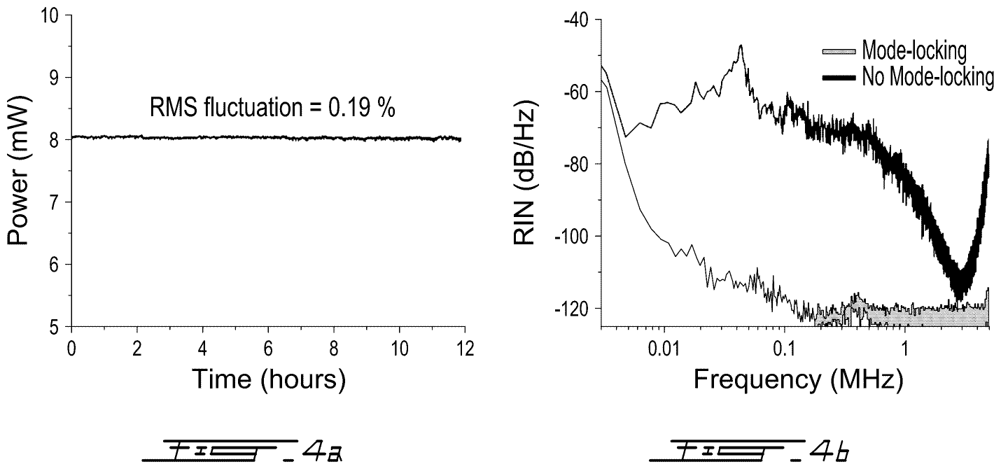

The presently disclosed mode-locking method and system are thus demonstrated for spectral broadening of the combs with lower pump thresholds. FIG. 3A shows that the increase of the resonator modes above one reduces the lasing threshold by about 17 times. Further increases in the number of beating modes does not affect the threshold, mostly due to the existence of stimulated parametric amplification arising from the energy exchange between the nearest comb lines. The central wavelength of the frequency comb may be continuously varied by tuning the central wavelength of the bandpass filter. FIG. 3B shows the measured spectrum of the frequency comb at a fixed filter bandwidth of 550 GHz for different central wavelengths. The mode-locked pulses subjected to stability measurement for sufficiently long duration and showed reliability against external noise (FIGS. 4), quantified by root-mean square fluctuations of 0.19% only. The measured relative intensity noise (RIN) characteristics of the laser >40 dB improvements in the intensity fluctuation when it is mode-locked. Using only active mode-locking with frequency modulation, i.e., carrier frequency with the modulation frequency, corresponding to the long fiber cavity, is thus shown to increase stability.

The presently disclosed frequency modulation driven active mode-locked laser method and system, using a microring resonator (MRR) nested in an external fiber cavity driven by frequency-modulated method for example, are shown to allow the coexistence of transform-limited pico-nanoseconds pulses, and switch between different pulse timescales thereby significantly improving laser operation based on the mode-locking threshold. This enhancement is achieved by selectively filtering numerous microring resonator (MRR) resonances. Moreover, the presently disclosed mode-locking method and system are flexible, with a flexible entirely energy-free control over the comb central wavelength.

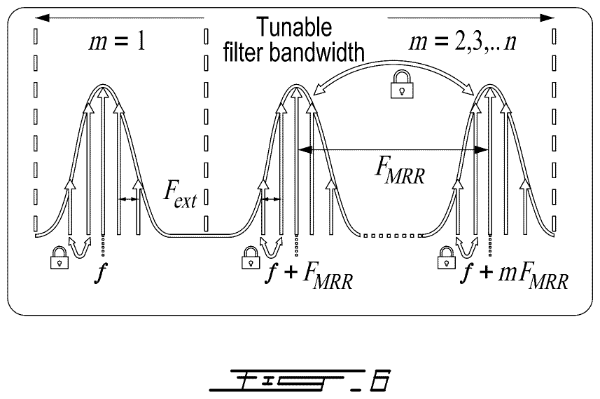

The presently disclosed system can switch between different modalities, which include generation of nanosecond pulses to pulse burst trains in which nanosecond and picosecond components coexist, with pulses with different timescales from picoseconds to nanoseconds; the system generates pulse burst trains where nanosecond and picosecond components coexist, as described further hereinbelow in the Annex (see FIG. 6).

The presently disclosed system allows reduction of mode-locking threshold by 17 times when more than one microring resonance is selected by tunable filter (see FIG. 3A).

There is thus presented a mode locking method and a mode locking system, with simultaneous generation of multiple time scale pulses i.e., ns and ps regimes, reduction of mode-locking threshold and generation of pulse burst trains, and a comb central wavelength lower than the frequency tunability.

Annex: mode-Locked laser with multiple timescales in a microresonator-based nested cavity.

Mode-locking techniques have played a pivotal role in developing and advancing laser technology. Stable fiber-cavity configurations can generate trains of pulses spanning from MHz to GHz speeds, which are fundamental to various applications in micromachining, spectroscopy, and communications. However, the generation and exploitation of multiple timescales in a single laser cavity configuration remain unexplored.

A fiber-cavity laser configuration for generating and controlling pulse trains from nanosecond to picosecond timescales with a broadband output and a low mode-locking threshold is described hereinbelow. A method using a frequency mode-locking mechanism that simultaneously drives the modes of an integrated microring resonator nested within an external fiber-loop cavity, guaranteeing ultra-stable operation, is used. Selectively filtering the nested cavity modes is used to transition from nanosecond pulses to pulse burst trains in which nanosecond and picosecond components coexist. The present laser configuration produces a train of pulses with durations of 5.1 ns and 3.1 ps at repetition rates of 4.4 MHz and 48.7 GHz, with time-bandwidth products close to the transform-limited values of 0.5 and 0.46, respectively. Moreover, in the absence of frequency modulation, the generation of comb spectra with an adjustable central wavelength was demonstrated.

The presently disclosed system and method have the potential to significantly contribute to the development of cutting-edge technologies and applications, harnessing the distinct advantages of mode-locked pulses across various scientific and engineering disciplines.

In the present disclosure, a mode-locked laser featuring an MRR nested in an external fiber-cavity configuration actively driven by an intracavity phase modulator (PM), allowing for laser operations characterized by the presence of multiple timescales, is presented. The presence of nanosecond pulses and regular pulse burst trains with nanosecond and picosecond components are reported. Selectively filtering the MRR resonances using an external cavity filter is used to switch between different timescales and significantly reduce the intracavity pump power, hence the mode-locking threshold. The dynamic control of laser operations through an adjustable filter-driven mechanism underscores the tunability and versatility of the presently disclosed system. The laser cavity is stabilized by applying a frequency-modulated (FM) electronic signal to the intracavity phase modulator (PM), establishing a fixed phase relationship between the external cavity modes and the MRR resonances.

Furthermore, in the absence of modulation, the present method provides the added benefit of directly tuning the central wavelength of the generated frequency comb, a capability lacking in traditional actively mode-locked lasers, where wavelength adjustment necessitates precise frequency modulation readjustment. In such mode operation, the generation of frequency combs with a tunable central wavelength spanning from 1.530 μm to 1.562 μm is demonstrated. This still represents a challenge for other wavelength tuning techniques involving mechanical, electro, or thermo-optical effects.

The presently disclosed method holds promises for numerous applications, such as micromachining and the realization of a pump source for mid-infrared pulse generation. At the same time, the realization of GHz microcombs finds applications in ultrafast precision spectroscopy, metrology, coherent communication, and optical computing.

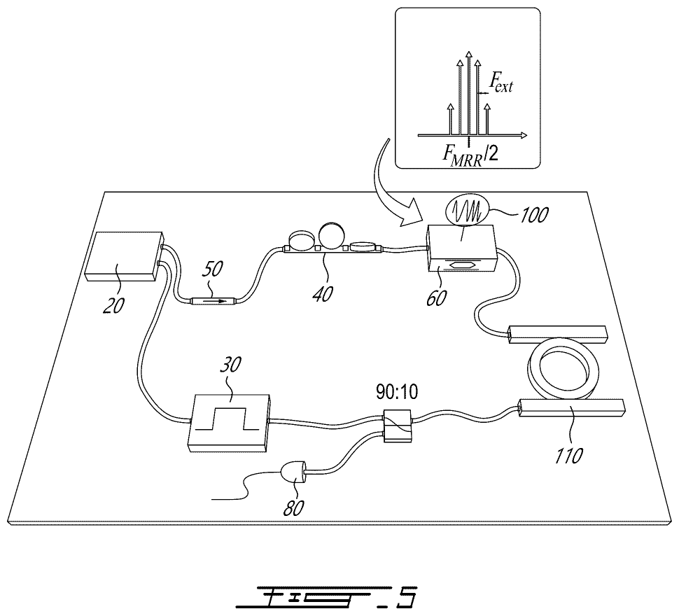

A mode-locking laser according to an embodiment of an aspect of the present disclosure as illustrated for example as shown in FIG. 5. In experiments herein, an erbium-doped fiber amplifier (EDFA) 20, a tunable filter 30, a polarization controller (PC) 40, an isolator 50 operating at the central wavelength of the main cavity mode (e.g., 1550 nm) and allowing light to propagate in only one direction, preventing back reflections that could destabilize the laser, a phase modulator (PM) 60 with a bandwidth of 40 GHz, a photodiode (PD) 80, a radiofrequency (RF) synthesizer 100 with tunable bandwidth ranging from 2 GHz to 40 GHz, and a microring resonator (MRR) 110 characterized by a nonlinear coefficient y about 200 W⁻¹Km⁻¹ and linear losses of about 0.06 dB/cm were used.

The tunable filter 30 can select a variable number of microring resonator (MRR) resonances within its bandwidth. The filter 30 used in the experiment is a tunable filter (200 GHz bandwidth about 1550 nm) that adjusts the wavelength to select microring resonator modes or resonances; alternatively, it may be a fixed-wavelength filter with a bandwidth of n times the microring resonator free spectral range (MRR FSR). It isolates specific wavelengths for precise control of optical signals. Filters may be based on different mechanisms, including etalon, diffraction grating, or thin-film technology for example. For example, a 90:10: A 90:10 optical coupler, also known as a fibre beam splitter, couples 10% of the cavity's resonant power while allowing 90% to pass through.

For thermal stability, the microring resonator (MRR) is mounted on a thermoelectric controller (not shown). The parameters of the erbium-doped fiber amplifier (EDFA) 20 are selected to sustain the lasing of the external cavity modes featuring a free-spectral range (Fext) of 4.4 MHz, specifically within the resonances of the microring resonator (MRR), whose free-spectral range (FMRR) is 48.7 GHz. These microring resonator (MRR) resonances act as filters, restricting the number of external modes allowed to oscillate in the laser.

The upper inset of FIG. 5 schematically illustrates the RF spectrum of the frequency-modulated signal that establishes a fixed phase relationship among all adjacent oscillation modes within multiple microring resonator (MRR) modes.

This configuration employs an integrated CMOS-compatible high-Q (Q=0.8×10⁶) MRR, which is made of a high-index glass (refractive index n=1.6) buried in silica with a cross-section of 3 μm×2 μm. The high nonlinear coefficient (γ about 200 W⁻¹km⁻¹) of the MRR is associated with the Kerr nonlinearity, as well as with low linear (about 0.06 dB/cm) and negligible nonlinear propagation losses. The MRR has a ring radius of 593 μm, with a free-spectral range FMRR=48.7 GHz and a resonance linewidth of about 100 MHz. The group velocity dispersion of the MRR is β₂ about −3 ps²/km and β₂ about −10 ps²/km at 1550 nm for the TM and TE modes, respectively, both featuring anomalous dispersion profiles around the wavelength range considered in the experiments. The input and output bus waveguides of the MRR are pigtailed to standard single-mode fibers via integrated mode converters employing a V-groove. The MRR, depicted in FIG. 5, is thermally stabilized using a thermoelectric controller with a feedback circuit to prevent thermal fluctuations, and is nested in the external fiber cavity, which also includes an erbium-doped fiber amplifier 20 (EDFA, maximum gain of 30 dB over the telecom C-band) from Keopsys Industries as the gain unit; a frequency tunable (C-band) Santec 950 optical filter 30 with adjustable bandwidth up to 6 nm; a polarization maintaining isolator 50, and a polarization controller 40. The tunable passband filter selects specific MRR resonances contributing to different laser regimes. The total optical length of the external fiber cavity is about 45.8 m, corresponding to a free-spectral range Fext about of 4.4 MHz. Therefore, a maximum number of about 22 external cavity modes can oscillate within each single MRR resonance. A 40 GHz bandwidth PM (EO Space, X-cut and low half-wave voltage), driven by an RF synthesizer (Rohde & Schwarz, tunable bandwidth from 2 GHz to 40 GHz), sustains an FM signal with a 4.4 MHz modulation frequency locked to a carrier of a frequency 24.35 GHz and a linewidth in the range of a few tens of KHz. The latter, in turn, actively phase-locks the external cavity and the MRR modes to the RF signal. The polarization controller sets the polarization in either the transverse magnetic or electric modes of the MRR, whose zero dispersion wavelengths are in the C-band and L-band, respectively. A 10% portion of the intracavity field is extracted from the cavity for spectral and temporal analysis via an Ando AQ6317B optical spectrum analyzer (OSA), a photodiode (40 GHz bandwidth), an oscilloscope (Agilent Dso-x 92804A, 28 GHz bandwidth), an electrical RF spectrum analyzer (HP E4407B, 25 GHz bandwidth), and an optical sampling scope (Exfo PSO-10, 500 GHz bandwidth).

The presence of the EDFA in the external cavity sustains the lasing of the external cavity modes that oscillate within the MRR resonances while filtering out the other external modes. The low anomalous dispersion of the MRR (<10 ps²/km) results in a negligible parametric phase-mismatch among these external cavity modes and induces highly efficient stimulated four-wave mixing (FWM), effectively broadening the overall spectral bandwidth of the frequency comb. However, the random beating between many external cavity modes within the MRR resonances leads to unstable operation without a mechanism that locks their phases. Therefore, actively modulating both the external cavity and the MRR modes is needed to ensure that a phase-locking condition is satisfied for the modes within each resonance and between the MRR resonances.

Since the analog bandwidths of the intracavity phase modulator (PM) and the RF synthesizer are limited to 40 GHz, the signal modulation is set to operate at a sub-harmonic of FMRR, which is 24.35 GHz. Consequently, each successive pair of generated tones aligns with the FMRR, while the spacing between the modulation components resonating inside the external laser cavity is equal to 4.4 MHz. When the filter bandwidth is 100 GHz, i.e. allowing the external cavity modes of two MRR resonances to oscillate, mode-locked pulse burst trains emerge with coexisting nanosecond and picosecond timescales. Simultaneous locking of both cavity modes, which produces dynamics with different timescales, is schematically depicted in FIG. 6.

FIG. 6 shows multiple timescales mode-locking according to an embodiment of an aspect of the present disclosure, by adjusting the external cavity filter bandwidth. The left handside of FIG. 6 shows nanosecond pulse trains generated using a single microring resonator (MRR) resonance within the external cavity filter bandwidth, and the right handside of FIG. 6 shows pulse burst trains generated using multiple (m) microring resonator (MRR) resonances within the filter bandwidth. By driving the phase modulator with a frequency-modulated signal (4.4 MHz modulation, 24.35 GHz carrier signal) generated by an RF synthesizer, a fixed phase relationship is established among the external cavity modes and microring resonator (MRR) resonances, which have free-spectral ranges Fₑₓₜ=4.4 MHz and F_{MRR}=48.7 GHz, respectively. The resultant frequency signal is centered at 48.7 GHz, while the spacing between the modulation components resonating inside the external laser cavity is equal to 4.4 MHz.

The pulse burst trains present nanosecond components with a repetition rate (REP) matching the external cavity free-spectral range Fext. The temporal profile is Gaussian with a 5.1 ns width, as shown in FIGS. 2A and 2B. This produces a transform-limited time-bandwidth product of 0.5, considering that the MRR resonance is approximately 100 MHz. FIG. 2C depicts highly coherent RF spectral components with 4.4 MHz spacing, measured by an electrical RF spectrum analyzer (25 GHz bandwidth). This indicates phase-locking among all the distinct external cavity modes oscillating inside the MRR resonances. The inset FIG. 2C illustrates a measured linewidth of 2.9 kHz for the fundamental RF tone, indicating the high stability of the laser repetition rate (REP). FIGS. 2A-2C depict the nanosecond timescale characterization of the mode-locked regime with two MRR resonances within the external filter bandwidth. The temporal and spectral profiles are such as those in the case of a single MRR resonance within filter bandwidth.

In the same experimental conditions, FIGS. 2D-2F demonstrate the presence of the picosecond timescale dynamics along with the nanosecond pulses described above due to the phase-locking among the MRR resonances driven by the GHz modulation. FIG. 2D shows the generated pulse train acquired using an optical sampling oscilloscope. The measured pulse dynamics exhibit a repetition rate of 48.7 GHz, aligning precisely with the free-spectral range of the MRR. The corresponding temporal pulse width is determined using intensity autocorrelation measurements, as illustrated in FIG. 2E, the profile of which shows a pulse shape with a width of 3.1 ps and a time-bandwidth product of 0.46. The features corresponding to this timescale remain absent in the radio frequency power spectrum (FIG. 2C) due to the bandwidth limitation of the photodiode.

While FIGS. 2D-2F illustrate the mode-locking for the TM polarization of the MRR, stable pulses are also obtained for the TE polarization, however, with marginally distinct pulse characteristics. The TM polarization has lower dispersion than the TE mode, leading to a more efficient FWM. Here, a larger broadening of the optical bandwidth results in a reduced pulse width. The TM modes was exclusively exploited in all experiments, as these feature parametric gains of 3.1 dB against 2.3 dB for the TE modes. Those values have been obtained by solving the coupled-wave equations in the framework of the nonlinear Schrodinger equation for degenerate FWM, considering an intra-cavity peak power of 0.56 W

Additionally, in this regime, the system exhibits a maximum average output power of 8.5 mW, achieved by increasing the cavity gain through the EDFA. This capability renders the laser cavity amenable to micromachining and microdrilling applications. The output becomes unstable beyond this power threshold, aligning with the behavior observed in standard fiber mode-locked lasers. One could explore optimization strategies such as dispersion management and external optical amplifiers to enhance the output power further.

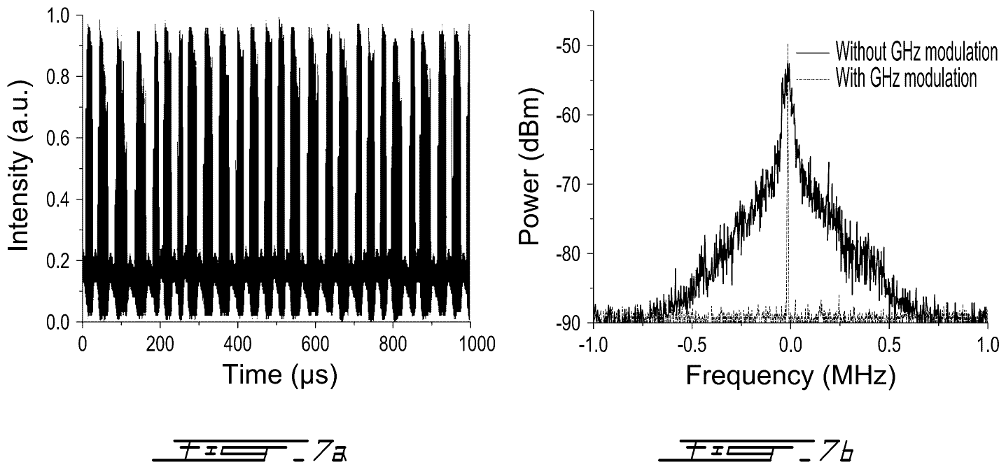

Without GHz modulation, the pulse train cannot be phase-locked, resulting from the superposition of multiple independent nanosecond pulses from each MRR resonance. Consequently, incoherent beating among the pulses arises, as shown in FIG. 7A. Such a beating is also proven by the broadening of the RF spectrum when modulation is absent (red line), with a linewidth of about 0.4 MHz, in contrast to the case in which modulation is instead present (blue line), as reported in FIG. 7B.

Switching from pulse burst trains to solely nanosecond pulse timescale is achieved by reducing the external cavity filter bandwidth to 50 GHz, which allows the transmission of only a single MRR resonance. In this regime, the EDFA gain was adjusted to 11 dB, achieving laser emission with pulses of 1.7 nJ energy, with a mode-locking threshold as low as 28 mW. Furthermore, the mode-locking operations are highly stable and robust against noise, resulting in over 12 hours of stable output, with root-mean-square fluctuations of 0.19% (see FIG. 4A) when both timescales coexist. To further validate this claim, the system relative intensity noise (RIN) was experimentally measured, as a performance parameter used to characterize pulse-to-pulse energy variations of mode-locked lasers. The relative intensity noise (RIN) characteristics of the laser with and without active mode-locking are compared in FIG. 4B, showing >40 dB improvements in the intensity fluctuation among the two cases within the 1 MHz frequency range.

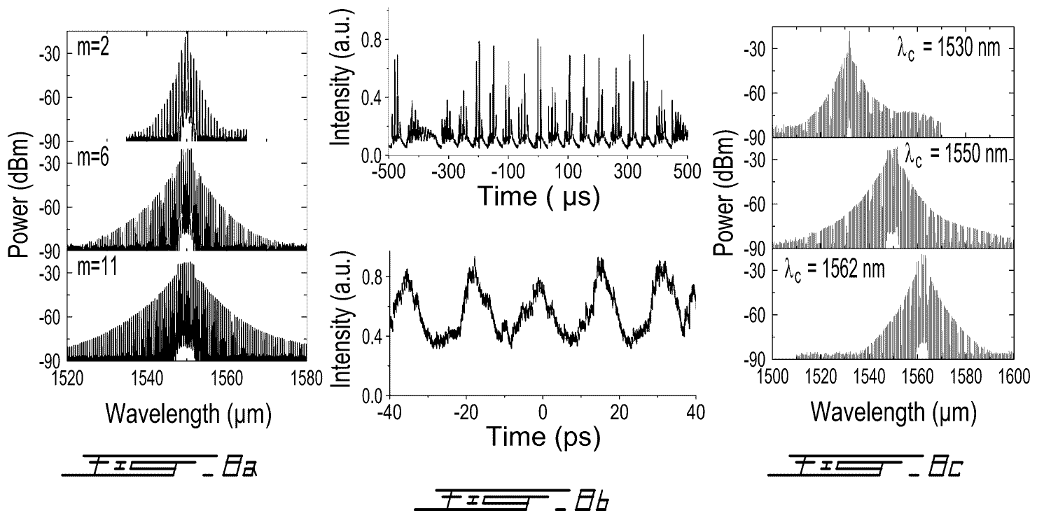

Without external frequency modulation, FIG. 8A shows the measured spectral profiles achieved with different resonant modes m=2, 6, and 11 corresponding to the passband filter bandwidths of 100 GHz, 300 GHz, and 550 GHz, respectively. Here, a broadening of the comb spectra due to FWM, from approximately 1.2 nm to 4.1 nm and 9.2 nm around 1550 nm, is observed, corresponding to increasing values of m. The FWM threshold decreases from 120 mW (one single MRR resonance within the filter passband) to 7 mW (two or more MRR resonances within the filter passband) as multiple MRR resonances are permitted within the bandwidth, i.e., with a threshold reduction of 17 times. This significant reduction is due to the energy exchange between the nearest MRR resonances, which are, in turn, seeded by the oscillating external cavity modes. Additional increases in MRR resonances do not further lower the threshold, primarily due to energy exchange between the nearest FWM-generated modes.

Still, the absence of frequency modulation leads to irregular pulsations in the nanosecond timescale, as illustrated in FIG. 8B. The autocorrelation trace in FIG. 8C for the same operational regime, characterized by low contrast autocorrelation, confirms the existence of a fast periodic modulation at 48.7 GHz. These shorter pulses undergo more substantial amplitude modulation, which increases statistical peak power variations. Such variations enhance nonlinear interactions and contribute to spectral broadening. On the other hand, in the presence of frequency modulation, the chirp introduced by the intracavity phase modulator (PM) is partially offset by self-modulation-induced chirp on the propagating pulses, limiting the conversion bandwidth of FWM. Such uncompensated chirp further contributes to the temporal broadening of the pulses due to cavity dispersion, ultimately reducing peak power and further limiting the efficiency of FWM power transfer between adjacent MRR resonances. Without modulation, there are no such limitations, and the spectrum broadens. This indicates that the dispersion management of the external cavity can lead to generating a broadband comb at femtosecond timescales. The optical spectrum of the generated frequency comb can be varied by tuning the central wavelength of the bandpass filter (fixed overall filter bandwidth of 550 GHz). The different generated combs have bandwidths of approximately 6.0 nm, 9.2 nm, and 7.8 nm, within 10 dB intensity variation, for λ_{c}=1530nm, 1550 nm, and 1562 nm, respectively.

The generation of a highly stable mode-locked laser using an MRR nested in an external optical fiber cavity was thus observed. Distinct mode-locked regimes characterized by multiple timescales, with nanosecond optical pulses associated with the free-spectral range of the external cavity modes and by the simultaneous presence of picosecond ultrafast pulses, respectively, were achieved. The latter reassembles the features of regular pulse burst trains with a spectral profile consistent with the two free-spectral ranges of the external cavity and the MRR at 4.4 MHz and 48.7 GHz repetition rates (REPs), respectively. The nanoseconds (5.1 ns) and picoseconds (3.1 ps) observed timescales correspond to transform limited time-bandwidth products of 0.5 and 0.46, respectively. Those are achieved above the mode-locked threshold of 28 mW, with a RIN showing ultra-low noise and high long-term stability. The presently disclosed method, by increasing the external cavity filter bandwidth, was shown to effectively control the transition from a nanosecond to a pulse burst train regime. Dispersion management components can further compress the generated pulses to sub-ps time scales.

In the absence of frequency modulation, the presently disclosed configuration facilitates the widening of the spectral bandwidth due to FWM, as two or more MRR resonances exchange energy within the external laser cavity.

In this regime, the central comb wavelength can be adjusted, thereby providing an extra degree of freedom to support the advancement of applications in frequency-domain spectroscopy, metrology, and dense wavelength division multiplexing for coherent communication.

The scope of the claims should not be limited by the embodiments set forth in the examples but should be given the broadest interpretation consistent with the description as a whole.

1. A mode-locking laser system, comprising:
an external cavity, selected for propagation of an optical field and propagating modes thereof;
a microring resonator, selected as a nested cavity to filter and resonate multiple external cavity modes, and applying nonlinearity on the optical field;
a gain unit, selected to amplify the optical field in the external cavity;
a polarization controller, selected to control a polarization state within the system;
a phase modulator, selected for actively modulating phases of nested cavity modes to achieve mode-locking;
a photodetector, selected for converting optical signals into electrical signals for detection;
a synthesizer, selected to generate a frequency-modulated signal for establishing a fixed phase relationship; and
a tunable filter, with a bandwidth selected to select a variable number of microring resonator resonances.

2. The mode-locking laser system of claim 1, wherein the microring resonator filters and applies nonlinearities on the optical field propagating in the external cavity; the gain unit sustains lasing of the external cavity modes; the polarization controller adjusts light polarization and thus the propagating field intensity; the phase modulator modulates the phases in synchronisation with the synthesizer for pulse generation; the photodetector detects signals; the synthesizer drives the phase modulator for frequency modulation; and the tunable filter works with the microring resonator to refine a spectral output of the system according to at least one of: phase, wavelength, polarization, spatial and temporal profiles and intensity of the propagating field.

3. The mode-locking laser system of claim 1, wherein the microring resonator is one of: a Fabry-Perot etalon, Bragg grating, photonic crystal resonator, and fiber loop resonator.

4. The mode-locking laser system of claim 1, wherein the external cavity is one of: an external fiber loop, a fiber loop cavity, an integrated loop cavity.

5. The mode-locking laser system of claim 1, wherein the gain unit is one of: an Erbium-doped fiber amplifier, a Raman amplifier, and a semiconductor optical amplifier.

6. The mode-locking laser system of claim 1, wherein the polarization controller is one of: a manual polarization controller, an automated polarization controller, a polarizing filter, a polarizing beam splitters, and a liquid crystal.

7. The mode-locking laser system of claim 1, wherein the photodetector is a photodiode.

8. The mode-locking laser system of claim 1, wherein the synthesizer is one of:
a RF synthesizer, a digital synthesizer, and an analog synthesizer.

9. The mode-locking laser system of claim 1, wherein the tunable filter is one of:
a diffraction grating-based filter and a thin-film filter.

10. The mode-locking laser system of claim 1, wherein the gain unit is an erbium-doped fiber amplifier having a free-spectral range within the resonances of the microring resonator selected for sustaining lasing of the external cavity modes, the photodetector is a photodiode, the synthesizer is a radiofrequency synthesizer with tunable bandwidth; the microring resonator resonances acting as filters, restricting a number of the external cavity modes allowed to oscillate in the system, the tunable filter being configured to select a number of the microring resonator resonances within the bandwidth thereof, a radiofrequency synthesizer spectrum of the frequency-modulated signal establishing a fixed phase relationship among all adjacent oscillation modes within multiple microring resonator modes; both the external cavity and the microring resonator modes being actively modulated to phase-locking condition for the modes within each resonance and between the microring resonator resonances.

11. The mode-locking laser system of claim 1, wherein mode-locked pulse burst trains emerge with coexisting nanosecond and picosecond timescales.

12. The mode-locking laser system of claim 1, with reduction of mode-locking threshold and broadband comb generation with tunable with reduction of mode-locking threshold and broadband comb generation with tunable central wavelength.

13. A mode-locking laser method, comprising:
selecting a microring resonator as a nested cavity to filter and resonate multiple external cavity modes and apply nonlinearity on an optical field;
selecting an external cavity, for propagation of the optical field and its propagating modes;
selecting a gain unit to amplify the optical field in the external cavity;
selecting a polarization controller to control a polarization state within the system;
selecting a phase modulator for actively modulating phases of the cavity modes to achieve mode-locking;
selecting a photodetector for converting optical signals into electrical signals for detection;
selecting a synthesizer to generate a frequency-modulated signal for establishing a fixed phase relationship; and
selecting a tunable filter to select a variable number of microring resonator resonances.

14. The mode-locking laser method of claim 13, comprising:
initializing and stabilizing the external cavity modes by configuring the gain unit and polarization controller, using the polarization controller to set the polarization in either transverse magnetic or electric modes of the microring resonator;
setting the tunable filter to select a number of microring resonator modes within a bandwidth of the tunable filter; and
extracting an ouput from the external cavity and temporal analysis via an optical spectrum analyzer, the photodetector and an oscilloscope.

15. The mode-locking laser method of claim 13, comprising:
initializing and stabilizing the external cavity modes by configuring the gain unit and polarization controller, using the polarization controller to set the polarization in either transverse magnetic or electric modes of the microring resonator;
adjusting the tunable filter bandwidth to include leasing a selected number of microring resonator modes within the external cavity loop;
setting active modulation on, by setting the synthesizer ON, an active mode-locking of the external cavity modes establishing a fixed phase relationship between all adjacent oscillation modes; and setting the synthesizer to drive the phase modulator; thereby actively phase-locking the external cavity and the microring resonator modes to the synthesizer signal; and
extracting an output of the intracavity field from the external cavity for spectral and temporal analysis via an optical spectrum analyzer, the photodiode, and the oscilloscope;
thereby generating mode-locked pulse burst trains with coexisting nanosecond and picosecond timescales.

16. The mode-locking laser method of claim 13, comprising:
initializing and stabilizing the external cavity modes by configuring the gain unit and polarization controller, using the polarization controller to set the polarization in either transverse magnetic or electric modes of the microring resonator;
setting active modulation OFF by setting the synthesizer OFF;
adjusting the tunable filter bandwidth to include leasing a selected number of microring resonator modes within the external cavity loop; and
extracting an output from the external cavity for spectral and temporal analysis via an optical spectrum analyzer, the photodiode, and an oscilloscope;
thereby switching from pulse burst trains to solely nanosecond pulse timescale.
